(19) United States
(12) Patent Application Publication
(10) Pub. No.: US 2002/0147006 A1
(43) Pub. Date: Oct. 10, 2002

(54) Proximity-based control of building functions

(76) Inventors: Bradley S. Coon, Kokomo, IN (US); Christopher A. Hedges, Greentown, IN (US); Douglas L. Welk, Rossville, IN (US)

Correspondence Address: STEFAN V. CHMIELEWSKI, DELPHI TECHNOLOGIES, INC., Legal Staff Mail Code-A-107, P.O. Box 9005, Kokomo, IN, 46904-9005, US

(21) Appl. No.: 09/828,678

(22) Filed: Apr. 9, 2001

(51) Int. Cl. H04M 3/00

(52) U.S. Cl. 455/420; 455/456; 455/445

(57) ABSTRACT

A proximity-based control system includes a stationary networked device, a control device and a wireless mobile device. The control device is coupled to and controls a networked device, according to a control routine that executes on the control device. The wireless mobile device is in communication with the control device, which initiates a function to be performed by the networked device according to the location and travel direction of the mobile device.

### TECHNICAL FIELD

The present invention is generally directed to controlling a stationary networked device and, more specifically, to remotely controlling a stationary networked device.

### BACKGROUND OF THE INVENTION

Historically, various devices have been remotely controlled to perform one or more functions. For example, commercially available automatic garage door openers have been remotely controlled to raise or lower a garage door, when a user actuates a remote transmitter. The remote transmitter has typically been located within a motor vehicle and has allowed remote actuation of the garage door when the remote transmitter was within range of a garage door controller. However, such systems have generally suffered from a number of drawbacks, which include the fact that the operating distance is limited by the design of the transmitter and once the range of the transmitter is exceeded, the device can no longer be remotely controlled. Further, such a remote transmitter has not traditionally been capable of controlling other devices (e.g., lights) located within a building. As such, device control functions have normally not been automated and events have generally only been initiated through user intervention. Additionally, status information on a given controlled device has, typically, not been available outside the line of sight of the user.

A number of manufacturers currently manufacture global positioning system (GPS) receivers that can accurately provide a user of the receiver with a correct position (e.g., a latitude and a longitude) for the receiver. The determination of the position of a given GPS receiver is made possible by a constellation of GPS satellites. GPS receivers have been utilized in a number of applications. For example, GPS receivers have been installed in a number of motor vehicle models and have typically been utilized in conjunction with various road mapping features, which provide travel directions to an occupant of the vehicle.

In an effort to enable mobile users to communicate, a number of manufacturers have designed and manufactured wireless communication devices, such as cellular telephones, which enable a user to communicate with other users linked by a wireless mobile communication system. While traditionally these wireless communication systems were implemented in analog circuitry, recently, many wireless communication systems have migrated to digital networks that can carry digital voice and data. Utilizing wireless digital communication systems, it is typically possible to establish an individual wireless data connection anywhere within the United States or, via satellites, anywhere in the world.

A number of manufacturers have also produced electronic aids for daily living (EADL), which are simply devices or systems that allow an individual to control many facets of their surrounding environment. EADLs are typically available as stand-alone units or as systems that utilize a personal computer (PC), running a control application. While some EADL systems are voice activated, many are switch activated. For example, devices that are commercially available allow appliances, such as lamps, blow dryers, fans and popcorn makers to be activated with the convenience of wireless control.

Further, other manufacturers have designed systems that use a PC that executes custom home lighting and appliance routines. However, these home systems are typically based on a timer routine. For example, a particular appliance is turned on or turned off at a specific time. While such systems work reasonably well for an individual with a predictable schedule, these systems have proven ineffective for people with variable schedules or when an unexpected schedule change occurs. For example, if an individual returns home or goes to the office at an unexpected hour, a time-based thermostat may have the office or home temperature adjusted to an uncomfortable level.

As such, what is needed is a proximity-based control system that controls various building functions based on the proximity of the individual to the building.

### SUMMARY OF THE INVENTION

The present invention is directed to a proximity-based control system that includes a stationary networked device, a control device and a wireless mobile device. The control device is coupled to and controls the networked device, according to a control routine that executes on the control device. The wireless mobile device is in communication with the control device, which initiates a function to be performed by the networked device according to the location and travel direction of the mobile device.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a block diagram of an exemplary proximity-based control system, according to one embodiment of the present invention;

FIG. 2 is a flowchart of an exemplary control device routine, according to another embodiment of the present invention; and

FIG. 3 is a flowchart of an exemplary mobile device routine, according to still another embodiment of the present invention.

### DESCRIPTION OF THE PREFERRED EMBODIMENT(S)

According to one embodiment of the present invention, a wireless mobile device is in communication with a control device and periodically provides its location to the control device. The control device then determines whether the mobile device is moving toward or away from the control device and if the control device is within a preprogrammed control range. If the mobile device is within a preprogrammed control range, the control device initiates performance of an appropriate function or functions, by the networked device or devices, through the issuance of an appropriate command or commands. In a preferred embodiment, the mobile device is located within a motor vehicle.

According to another embodiment of the present invention, the wireless mobile device determines its own location with respect to the control device. When the mobile device is within a predetermined control range, the mobile device sends a message to the control device to initiate performance of an appropriate function or functions, by the networked device or devices. In this manner, various building functions can be initiated based upon the location of the wireless mobile device.

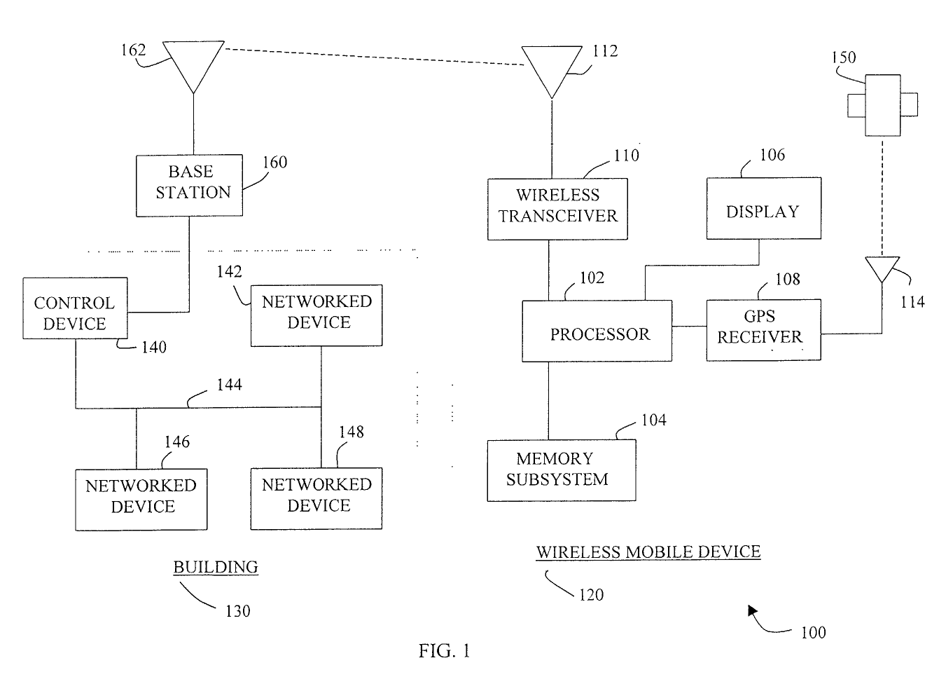

FIG. 1 depicts an exemplary proximity-based control system 100 that includes a wireless mobile device 120 implemented within, for example, a motor vehicle. The mobile device 120 communicates with a control device 140 located within, for example, a building 130. The mobile device 120 includes a processor 102 that is coupled to a display 106, a GPS receiver 108, a memory subsystem 104 and a wireless transceiver 110. The GPS receiver 108 receives various communications from a plurality of GPS satellites 150, through an antenna 114, and provides a location indication to the processor 102. The processor 102 then provides the location of the mobile device 120, via a wireless transceiver 110 (and antenna 112), to a base station 160 via an antenna 162. Alternatively, the processor 102 may transmit a control message to the control device 140, based upon the location information. In this embodiment, upon receiving the control message, the control device 140 initiates performance of an appropriate function or functions, by at least one networked device.

As shown in FIG. 1, the base station 160 is coupled to the control device 140. In one embodiment, the control device 140 is a personal computer (PC) that includes a modem that is coupled to a telephone line and, in turn, the Internet, via an Internet service provider (ISP) (not shown). Alternatively, the control device may be coupled to the Internet via a cable modem or a digital subscriber line (DSL). In these embodiments, the base station 160 communicates with the control device 140, via the Internet. In this manner, the control device 140 can communicate with the wireless mobile device 120. Alternatively, the control device 140 may include its own wireless transceiver and antenna (not shown) such that it can wirelessly communicate with the base station 160 and, in turn, the mobile device 120.

The control device 140 is coupled, via a network 144, to a plurality of networked devices 142, 146 and 148. The networked devices 142, 146 and 148 may be any of a number of devices that are normally located within a building, for example, a security system, a smoke detector, a light, a coffeemaker, a garage door opener, an electric door lock, a thermostat and a curtain, among other devices. In a preferred embodiment, the control device 140 is programmed such that when location information provided by the mobile device 120 indicates the mobile device 120 is within a certain range, the control device 140 causes one or more functions to be performed by the networked devices 142, 146 and 148.

For example, when the mobile device 120 is within three-hundred feet of the control device 140, the control device 140 may cause a security system to be disarmed, a light to be illuminated, a garage door to be opened, a door lock to be unlocked, a thermostat to be set to an appropriate level and one or more curtains to be closed or opened. As another example, when the mobile device 120 moves more than three-hundred feet away from the control device 140, the control device 140 may cause the security system to be armed and a door to be locked. The mobile device 120 may be a variety of types such as a handheld computer system (e.g., a personal digital assistant (PDA)) or a portable cellular telephone. When employed within a motor vehicle, wireless connectivity may be achieved, for example, through a digital cellular telephone, MOBITEX®, a cellular digital packet data (CDPD) modem, a two-way paging system or a short message service (SMS) transceiver. Further, it is also envisioned that the GPS receiver 108 can alternatively be replaced with a wireless infrastructure positioning (E-911) type system.

As previously mentioned, a proximity-based control system, according to an embodiment of the present invention, can advantageously be utilized by individuals that have unpredictable schedules, variable schedules or when an unexpected schedule change occurs. According to another embodiment of the present invention, the control device 140 can provide status information on various networked devices 142, 146 and 148 to the mobile device 120, as desired. For example, when the networked device is a water softener that is capable of determining when it is low on salt, it can provide the status information to the control device 140. The control device 140 then sends a message to the mobile device 120, which may be incorporated within a motor vehicle. Based upon the proximity of the motor vehicle to a store, an audio subsystem of the vehicle may then inform the driver of the need to purchase salt and provide the location of a store that is currently between the mobile device 120 and the control device 140.

The control device 140 may provide other status information to the mobile device 120 in response to a request by the mobile device 120 or according to a routine executing on the control device 140. According to another embodiment of the present invention, the control device 140 can initiate the starting of a motor vehicle and setting of various motor vehicle accessories, when the mobile device 120 is located within the motor vehicle. For example, a user may access a vehicle home page via an Internet browser or other dedicated control program on a PC. The user may then have the option of starting the vehicle with a default personalized profile. The user may then manually enter data into various fields to set the climate control temperature, tune the radio, open the sliding door, etc. The motor vehicle may then respond by dynamically posting real-time data on a diagnostic page and alert the user if there is a problem or if it is time, for example, for periodic maintenance.

When periodic maintenance is to be performed, the PC may search for local service specials on the Internet and present various service options to the user. If desired, the vehicle profile and diagnostic information can be sent to a selected service center with which an appointment is scheduled. In this manner, the motor vehicle can be started remotely and may provide real-time diagnostic information to the user. Further, the user can personalize individual features of the vehicle manually via the PC.

According to the present invention, building (e.g., residence and office) functions are automatically activated and deactivated without user intervention, based solely on the proximity and direction of travel of the mobile device 120. Further, portions of such a proximity-based control system can normally be readily integrated within an existing electronic subsystem of most motor vehicles, with essentially no hardware impact and minimal software impact. One of ordinary skill in the art will readily appreciate that in order to control a particular networked device, it must normally be networked with a control device (such as the control device 140), which is capable of receiving communications from the mobile device 120.

As will be further discussed below, the decision making software can be implemented within the control device 140 or within the mobile device 120. According to the invention, a user may automatically control any device that is connected to the control device 140. Preferably, the distance threshold, hysteresis and the desired action(s) taken at the threshold are fully configurable by the user. As such, it is possible for the programmed functions to be initiated with no user interaction. In this manner, a user can, for example, automatically arm or disarm a building security system as a function of the location of the mobile device 120. According to another embodiment of the present invention, status information is available to a user of the mobile device. The status information can, for example, correspond to the fact that a building (e.g., a residence and an office) security system has been breached and may also be provided to the police, via a wired or wireless connection. The network 144 can be implemented as, for example, an X10™ or a HOMERF® network.

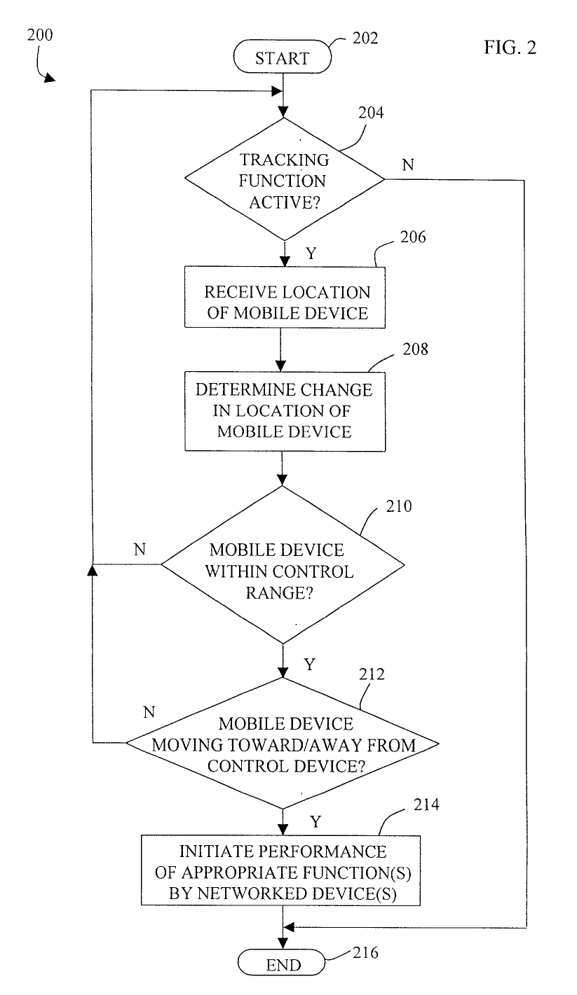

FIG. 2 depicts a flowchart of a control device routine 200, which executes on the control device 140 and receives the location of the mobile device 120, according to an embodiment of the present invention. In step 202, the routine 200 is initiated, at which point control transfers to decision step 204. In step 204, the control device 140 determines whether the tracking function is active. If the tracking function is active, control transfers from step 204 to step 206. Otherwise, control transfers to step 216, where the routine 200 terminates. In step 206, the control device 140 receives the location of the mobile device 120. Next, in step 208, the control device 140 determines the change in the location of the mobile device 120. Then, in decision step 210, the control device 140 determines whether the mobile device 120 is within a preprogrammed control range.

If the mobile device 120 is not within a preprogrammed control range, control transfers from step 210 to step 204. Otherwise, control transfers from step 210 to decision step 212. In step 212, the control device 140 determines whether the mobile device 120 is moving toward or away from the control device 140. If the mobile device 120 is moving toward or away from the control device 140, control transfers to step 214 . Otherwise, control transfers from step 212 to step 204. In step 214, the control device 140 initiates performance of an appropriate function or functions by sending an appropriate command to a networked device or multiple networked devices. After initiating performance of the appropriate functions, control transfers to step 216 where routine 200 terminates.

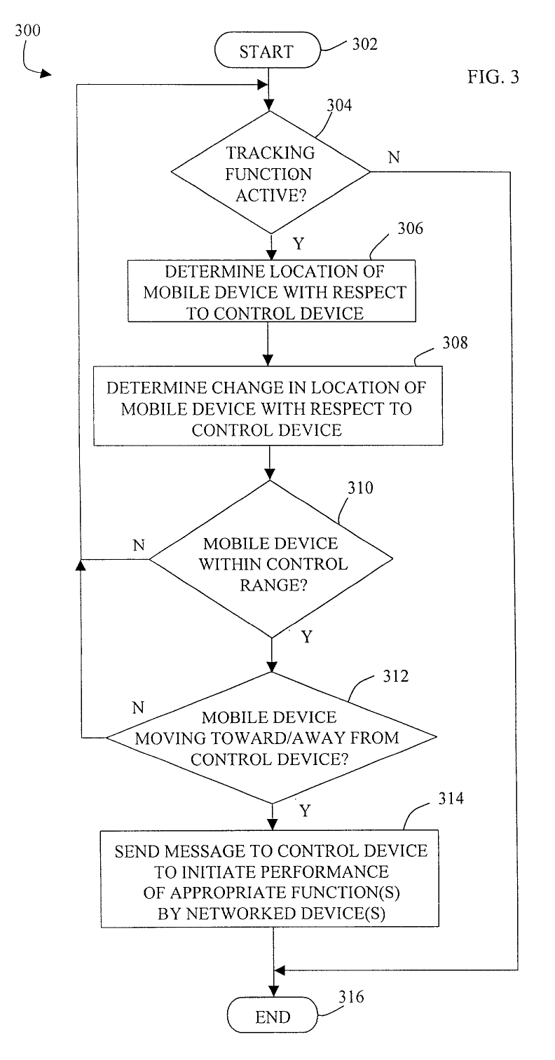

FIG. 3 illustrates a mobile device routine 300, which executes on the processor 102 and provides an appropriate command to the control device 140, based on the location of the mobile device 120 with respect to the control device 140. The received command causes the control device 140 to initiate an appropriate function or functions by an appropriate networked device 142, 146 and 148, according to another embodiment of the present invention. In step 302, the routine 300 is initiated, at which point control transfers to decision step 304. In decision step 304, the processor 102 determines whether the tracking function is active. If so, control transfers to step 306. Otherwise, control transfers to step 316, where the routine 300 terminates. In step 306, the processor 102 determines the location of the mobile device 120 with respect to the control device 140. Next, in step 308, the processor 102 determines the change in location of the mobile device 120 with respect to the control device 140.

Then, in decision step 310, the processor 102 determines whether the mobile device 120 is within a preprogrammed control range. If the mobile device 120 is within the preprogrammed control range, control transfers to decision step 312. Otherwise, control transfers from step 310 to step 304. In step 312, the processor 102 determines whether the mobile device 120 is moving toward or away from the control device 140. If the mobile device 120 is moving toward or away from the control device 140, control transfers to step 314. Otherwise, control transfers from step 312 to step 304. In step 314, the processor 102 causes an appropriate message (i.e., a message that corresponds to the location of the mobile device 120, with respect to the control device 140) to be sent to the control device 140 via wireless transceiver 110, antenna 112, antenna 162 and base station 160. The control device 140 then initiates performance of an appropriate function or functions by an appropriate networked device or devices. Next, in step 316, routine 300 terminates.

Accordingly, a proximity-based control system has been described that allows a control device to initiate the performance of various functions by a number of stationary networked devices, according to the location of the mobile device. In one embodiment, the control device receives the location information from the mobile device and determines whether an appropriate function should be performed by one of the networked devices. In another embodiment, the mobile device determines its location with respect to the control device and sends an appropriate message to the control device such that the control device initiates performance of a particular function or functions by a networked device or multiple networked devices. As described above, embodiments of the present invention can advantageously be implemented within a motor vehicle.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the Doctrine of Equivalents.

1. A method for remotely controlling a stationary networked device based upon the proximity of a wireless mobile device, wherein the stationary networked device is coupled to a control device for controlling the networked device, the method comprising the steps of:
determining a location of a wireless mobile device;
initiating a communication between the mobile device and the control device; and
controlling a networked device according to a control routine that is executing on the control device, wherein a function performed by the networked device is determined by the location and travel direction of the mobile device.

2. The method of claim 1, wherein the communication is initiated between the mobile device and the control device according to one of the location of the mobile device with respect to the control device and a predetermined time period.

3. The method of claim 1, wherein the wireless mobile device is located within a motor vehicle and the control device and networked device are located within one of a residence and a business.

4. The method of claim 3, wherein the location of the mobile device is determined by a global positioning system (GPS) receiver that is also located within the motor vehicle.

5. The method of claim 3, wherein the location of the mobile device is determined by a wireless infrastructure positioning receiver that is also located within the motor vehicle.

6. The method of claim 1, further including the step of:
determining a travel direction of the wireless mobile device.

7. The method of claim 6, wherein the travel direction of the mobile device is determined by evaluating the change in the location of the mobile device.

8. The method of claim 1, wherein the networked device includes at least one of a security system, a smoke detector, a light, a coffee maker, a garage door opener, a door lock, a thermostat and a curtain, and wherein the control device is a personal computer (PC).

9. The method of claim 1, wherein the wireless mobile device is a handheld computer system that includes a wireless modem and the control device and the networked device are located within one of a residence and a business.

10. The method of claim 1, wherein the wireless mobile device is portable telephone that supports location detection and the control device and the networked device are located within one of a residence and a business.

11. The method of claim 1, further including the steps of:
providing status information about the networked device to the wireless mobile device; and
providing control information from the wireless mobile device to the networked device, the networked device performing a function that corresponds to the control information.

12. The method of claim 1, further including the step of:
providing control information from the control device to the wireless mobile device.

13. A proximity-based control system, comprising:
a stationary networked device;
a control device coupled to and controlling the networked device, wherein the control device controls the networked device according to a control routine that is executing on the control device; and
a wireless mobile device in communication with the control device, wherein a function performed by the networked device is determined by a location and travel direction of the mobile device.

14. The system of claim 13, wherein the communication is initiated between the mobile device and the control device according to one of the location of the mobile device with respect to the control device and a predetermined time period.

15. The system of claim 13, wherein the wireless mobile device is located within a motor vehicle and the control device and the networked device are located within one of a residence and a business.

16. The system of claim 15, wherein the location of the mobile device is determined by a global positioning system (GPS) receiver that is also located within the motor vehicle.

17. The system of claim 15, wherein the location of the mobile device is determined by a wireless infrastructure positioning receiver that is also located within the motor vehicle.

18. The system of claim 13, wherein the control device determines a travel direction of the wireless mobile device.

19. The system of claim 18, wherein the control device determines the travel direction of the mobile device by evaluating the change in the location of the mobile device.

20. The system of claim 13, wherein the networked device includes at least one of a security system, a smoke detector, a light, a coffee maker, a garage door opener, a door lock, a thermostat and a curtain, and wherein the control device is a personal computer (PC).

21. The system of claim 13, wherein the wireless mobile device is a handheld computer system that includes a wireless modem and the control device and the networked device are located within one of a residence and a business.

22. The system of claim 13, wherein the wireless mobile device is a portable telephone that supports location detection and the control device and the networked device are located within one of a residence and a business.

23. The system of claim 13, wherein the control device provides status information about the networked device to the wireless mobile device and the wireless mobile device provides control information to the networked device, the networked device performing a function that corresponds to the control information.

24. The system of claim 13, wherein the control device provides control information to the wireless mobile device.

25. A proximity-based control system, comprising:
a stationary networked device located within one of a residence and a business;
a control device coupled to and controlling the networked device, wherein the control device controls the networked device according to a control routine that is executing on the control device; and
a wireless mobile device in communication with the control device, wherein the wireless mobile device is located within a motor vehicle, and wherein a function performed by the networked device is determined by a location and travel direction of the mobile device.

26. The system of claim 25, wherein the communication is initiated between the mobile device and the control device according to one of the location of the mobile device with respect to the control device and a predetermined time period.

27. The system of claim 25, wherein the location of the mobile device is determined by a global positioning system (GPS) receiver that is also located within the motor vehicle.

28. The system of claim 25, wherein the location of the mobile device is determined by a wireless infrastructure positioning receiver that is also located within the motor vehicle.

29. The system of claim 25, wherein the control device determines a travel direction of the wireless mobile device.

30. The system of claim 29, wherein the control device determines the travel direction of the mobile device by evaluating the change in the location of the mobile device.

31. The system of claim 25, wherein the networked device includes at least one of a security system, a smoke detector, a light, a coffee maker, a garage door opener, a door lock, a thermostat and a curtain, and wherein the control device is a personal computer (PC).

32. The system of claim 25, wherein the wireless mobile device is a handheld computer system that includes a wireless modem and the control device and the networked device are located within one of a residence and a business.

33. The system of claim 25, wherein the wireless mobile device is a portable telephone that supports location detection and the control device and the networked device are located within one of a residence and a business.

34. The system of claim 25, wherein the control device provides status information about the networked device to the wireless mobile device and the wireless mobile device provides control information to the networked device, and wherein the networked device performs a function that corresponds to the control information.

35. The system of claim 25, wherein the control device provides control information to the wireless mobile device.
